(19) United States
(12) Patent Application Publication
(10) Pub. No.: US 2008/0220271 A1
(43) Pub. Date: Sep. 11, 2008

(54) Use of Thermoplastic for the Thermal Protection of Substrates

(75) Inventors: Martin Baumert, Dossenheim (DE); Jean-Jacques Flat, Goupillieres (FR); Nicolas Amouroux, Kyoto (JP)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colombes (FR)

(21) Appl. No.: 11/815,686

(22) PCT Filed: Feb. 10, 2006
(86) PCT No.: PCT/FR06/00306

§ 371 Date: Mar. 19, 2008

(30) Foreign Application Priority Data
Feb. 11, 2005 (FR) 0501400

(51) Int. Cl. C08L 77/00; B32B 27/34

(52) U.S. Cl. 428/474.4; 525/178

(57) ABSTRACT

The invention relates to the use of a thermoplastic composition in a nanostructured form, said composition essentially comprising a grafted copolymer with polyamide blocks, consisting of a polyolefin trunk selected from the maleic ethylene anhydride and maleic alkyl anhydride ethylene (meth)acrylate copolymers, and at least one polyamide graft, for the thermal protection of a substrate, at a temperature higher than 150° C. The invention is characterised in that at least one layer of said composition is deposited on the substrate. According to a preferred embodiment, the coating layer is deposited by coextrusion on the substrate layer, especially for obtaining tubes or pipes used in petrol lines.

The present invention relates to the use of a thermoplastic composition in nanostructured form, mainly composed of a grafted functional ethylenic copolymer having polyamide blocks for the thermal protection of various substrates or the production of products or parts having thermal stability at high temperature.

Described in document WO 02/28959 is a graft copolymer having polyamide blocks on a polyolefin backbone that is chosen from ethylene/maleic anhydride and ethylene/alkyl(meth)acrylate/maleic anhydride copolymers, forming a co-continuous nanostructured blend; this gives this copolymer exceptional thermomechanical properties, which are retained when redispersing this graft copolymer in flexible polyolefins such as the flexible ethylene polymers.

Such blends have applications as adhesives, films, tarpaulins, calendered products, electrical cables or powders for slush-molding processes.

In the current state of the art, the thermoplastic products used to improve thermal stability and behavior are polymers such as thermoplastic elastomers (for example SANTOPRENE® from Exxon, which comprises a polypropylene (PP) matrix in which an ethylene-propylene-diene monomer (EPDM) copolymer is dispersed), chlorinated polymers (SUNPRENE® from Arkema) and “super” thermoplastic vulcanizates (Super-TPVs) (for example of the ETPV type from DuPont and TPSiV type from Dow Corning Multibase).

The Applicant has succeeded in defining the compositional (polyolefin/polyamide) domain, combining the flexibility of polyolefins with the thermal behavior of polyamides, and also the type and level of stabilizers to obtain products that display excellent thermal stability and behavior above 150° C. and even above 200° C. The mechanical properties are hardly changed after aging up to this temperature.

The present invention relates to the use of a thermoplastic composition in nanostructured form, mainly composed of a graft copolymer having polyamide blocks formed from a polyolefin backbone, chosen from ethylene/maleic anhydride and ethylene/alkyl (meth)acrylate/maleic anhydride copolymers, and from at least one polyamide graft, for the thermal protection, at a temperature above 150° C., of a substrate, characterized in that at least one layer of this composition is deposited on the substrate.

According to the invention, the polyolefin backbone is an ethylene/alkyl(meth)acrylate/maleic anhydride terpolymer.

According to the invention, the grafts are homopolymers formed from residues of caprolactam, 11-aminoundecanoic acid or dodecalactam or copolyamides formed from residues chosen from at least two of the previous three monomers.

Preferably, the polyamide grafts are mono-NH₂-terminated PA-6 polyamide or mono-NH₂-terminated PA-6/11 copolyamide, and have a molecular weight between 1000 and 5000 g/mol.

Moreover, the coatings obtained by depositing the thermoplastic composition according to the invention are suitable as thermally protective layers both for supports or substrates that are soft or flexible and for those that are rigid.

The term “support or substrate” is understood to mean any type of synthetic (thermoplastic or thermosetting) polymer material, or natural material of mineral or plant origin, and also metallic materials.

The present invention in particular relates to the use of the thermoplastic composition of the invention to coat a substrate that is flexible and produced from polyamide, in particular of PA-11 or PA-12 type.

According to the invention, the coating layer is deposited by coextrusion onto the substrate layer, in particular for producing pipes or tubes.

In particular, these tubes or pipes find a preferred application in fluid transfer lines, in particular two-layer type tubes for petrol, comprising an inner layer of PA-11 and/or PA-12 type polyamide and an outer layer formed from the thermoplastic composition of the invention.

However, the invention is not limited to the production of coatings in the form of a single layer, but also relates to multilayer coatings, in particular for composite structures.

The present invention also relates to the use of a thermoplastic composition in nanostructured form, mainly composed of a graft copolymer having polyamide blocks formed from a polyolefin backbone, chosen from ethylene/maleic anhydride and ethylene/alkyl (meth)acrylate/maleic anhydride copolymers, and from at least one polyamide graft, for producing products or parts exhibiting thermal stability at a temperature above 200° C.

This field of application in particular relates to the static seals and parts used under the engine hood in automobile construction.

The original properties and advantages of the invention relative to the current state of the art are:
the structure of the alloys of the invention (the combination of the flexibility of a polyolefin and the thermal behavior of a polyamide is provided by a co-continuous structure, stabilized due to the nanostructuring);
the combination of thermal stability, hydrolytic stability and thermoplastic convertibility; and
the two-layer structure which may be made in a single step by coextrusion, without a tie layer between these layers.

The advantages may be summarized thus:
relative to the thermoplastic elastomers (TPEs) and chlorinated polymers (PVC):

| | | Composition |
|---|---|---|
| | | according to the |
| | TPE/PVC | invention |
| Processability | Low speed | High speed |
| (tube extrusion) | | |
| Hydrolysis | <150° C. | >150° C. |
| resistance | | |
| Heat resistance | <150° C. | >150° C. |
| Adhesive layer | Required (for PA | No binder required |
| | and PE) | for PA(polyamide), |
| | | PP(polypropylene), |
| | | PE(polyethylene) |

relative to the “super” thermoplastic vulcanizates:

| | ETPV | |
|---|---|---|
| | Copolyester matrix + | Composition |
| | crosslinked | according to the |
| | ethylene acrylate | invention |
| Processability | Low speed | High speed |
| (tube extrusion) | | |
| Hydrolysis | <100° C. | >150° C. |
| resistance | | |
| Adhesive layer | Required (for PA | No binder required |
| | and PE) | for PA, PP, PE |

Among the advantages due to this covering for the two-layer tubes, the elongation and impact properties of the tube sheathed (with a coating) are greater than that of the tube alone:
the elongation exceeds 300% as the PA tube has not been in contact with the bore; and
the impact strength: since the thermoplastic compositions according to the invention have an extremely low ductile-brittle transition (<−50° C. in Charpy notched impact), the impact strength is excellent.

The main constituent of the thermoplastic composition whose use is the subject of the present invention will be described in greater detail.

Regarding the graft copolymer having polyamide blocks, it may be obtained by reaction of an amine-terminated polyamide with the residues of an unsaturated monomer X attached by grafting or copolymerization to a polyolefin backbone.

This monomer X may be, for example, an unsaturated epoxide or an unsaturated carboxylic acid anhydride. The unsaturated carboxylic acid anhydride may be chosen, for example, from maleic, itaconic, citraconic, allyl succinic, 1,2-cyclohex-4-enedicarboxylic, 4-methylene-1,2-cyclohex-4-enedicarboxylic, bicyclo[2.2.1]hept-5-ene-2,3-dicarboxylic and x-methylbicyclo[2.2.1]hept-5-ene-2,2-dicarboxylic anhydrides. Advantageously maleic anhydride is used. It would not be outside the scope of the invention to replace all or some of the anhydride with an unsaturated carboxylic acid such as, for example, (meth)acrylic acid. Examples of unsaturated epoxides have been mentioned above.

Regarding the polyolefin backbone, a polyolefin is defined as a homopolymer or copolymer of α-olefins or diolefins, such as for example ethylene, propylene, 1-butene, 1-octene or butadiene. By way of example, mention may be made of:
nomopolymers and copolymers of polyethylene, in particular LDPE, HDPE, LLDPE (linear low density polyethylene), VLDPE (very low density polyethylene) and metallocene polyethylene;
homopolymers or copolymers of propylene;
ethylene/α-olefin copolymers such as ethylene/propylene copolymers, EPRs (ethylene-propylene rubber) and ethylene-propylene-diene monomer (EPDM) copolymers;
styrene/ethylene-butene/styrene (SEBS), styrene/butadiene/styrene (SBS), styrene/isoprene/styrene (SIS) and styrene/ethylene-propylene/styrene (SEPS) block copolymers; and
copolymers of ethylene with at least one product chosen from salts or esters of unsaturated carboxylic acids such as alkyl(meth)acrylate (for example methyl acrylate), or vinyl esters of saturated carboxylic acids such as vinyl acetate, the amount of comonomer possibly reaching 40% by weight.

Advantageously, the polyolefin backbones onto which the X residues are attached are polyethylenes grafted by X or copolymers of ethylene and X that are obtained, for example, by radical polymerization.

Regarding the polyethylenes onto which X will be grafted, polyethylene is understood to mean ethylene homopolymers or copolymers.

As comonomers, mention may be made of:
α-olefins, advantageously those having from 3 to 30 carbon atoms. Examples have been mentioned above. These α-olefins may be used alone or as a blend of two or more than two;
esters of unsaturated carboxylic acids such as for example alkyl(meth)acrylates, the alkyl groups possibly having up to 24 carbon atoms, examples of alkyl acrylates or methacrylates are especially methyl methacrylate, ethyl acrylate, n-butyl acrylate, isobutyl acrylate and 2-ethylhexyl acrylate;
vinyl esters of saturated carboxylic acids such as for example vinyl acetate or vinyl propionate;
dienes, such as for example 1,4-hexadiene; and
the polyethylene may comprise several of the preceding comonomers.

Advantageously, the polyethylene, which may be a blend of several polymers, comprises at least 50% and preferably 75% (in moles) of ethylene, its density may be between 0.86 and 0.98 g/cm³. The MFI (melt flow index at 190° C./2.16 kg) is advantageously between 20 and 1000 g/10 min.

As examples of polyethylenes, mention may be made of:
low density polyethylene (LDPE);
high density polyethylene (HDPE);
linear low density polyethylene (LLDPE);
very low density polyethylene (VLDPE);
polyethylene obtained by metallocene catalysis;
EPR (ethylene-propylene rubber) elastomers;
EPDM (ethylene-propylene-diene monomer) elastomers;
blends of polyethylene with an EPR or an EPDM; and
ethylene/alkyl(meth)acrylate copolymers possibly containing up to 60% by weight of (meth)acrylate and preferably 2 to 40%.

Grafting is an operation known per se.

Regarding the copolymers of ethylene and X, that is to say those in which X is not grafted, these are copolymers of ethylene, of X and optionally of another monomer possibly being chosen from the comonomers that were mentioned above for the ethylene copolymers intended to be grafted.

Advantageously, the ethylene/maleic anhydride and ethylene/alkyl(meth)acrylate/maleic anhydride copolymers are used. These copolymers comprise from 0.2 to 10% by weight of maleic anhydride, from 0 to 40% and preferably 5 to 40% by weight of alkyl(meth)acrylate. Their MFI is between 5 and 100 (measured at 190° C. under a load of 2.16 kg). The alkyl(meth)acrylates have already been described above. The melting point is between 60 and 120° C.

Advantageously, there are on average at least 2 mol of X per chain attached to the polyolefin backbone and preferably from 2 to 5. A person skilled in the art may easily determine the number of these X moles by FTIR analysis. For example, if X is maleic anhydride and the polyolefin backbone has a weight-average molecular weight M_{w}=95 000 g/mol, it has been found that this would correspond to an amount of anhydride of at least 1.5%, preferably from 2.5 to 4%, by weight of the whole polyolefin backbone containing X. These values associated with the weight of the amine-terminated polyamides determine the amount of polyamide and of backbone in the graft copolymer having polyamide blocks.

Regarding the amine-terminated polyamide, the term “polyamide” is understood to mean the condensation products of:
one or more amino acids, such as aminocaproic, 7-aminoheptanoic, 11-aminoundecanoic and 12-aminododecanoic acids with one or more lactams such as caprolactam, oenantholactam and lauryl lactam;
one or more salts or mixtures of diamines such as hexamethylenediamine, dodecamethylenediamine, meta-xylylenediamine, bis-(p-aminocyclohexyl)methane and trimethylhexamethylenediamine with diacids such as isophthalic, terephthalic, adipic, azeleic, suberic, sebacic and dodecanedicarboxylic acids; or
blends of several monomers that result in copolyamides.

Blends of polyamides may be used. Advantageously PA-6, PA-11, PA-12, the copolyamide having 6 units and 11 units (PA-6/11), the copolyamide having 6 units and 12 units (PA-6/12) and the copolyamide based on caprolactam, hexamethylenediamine and adipic acid (PA-6/6,6) are used. The advantage of the copolyamides is that it is thus possible to choose the melting point of the grafts.

The degree of polymerization may vary by large amounts, depending on its value it is a polyamide or a polyamide oligomer. In the remainder of the text either one of the two expressions will be used for the grafts.

So that the polyamide has a monoamine termination, it is sufficient to use a chain stopper of formula:

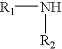

in which:
R₁ is hydrogen or a linear or branched alkyl group containing up to 20 carbon atoms; and
R₂ is a linear or branched, alkyl or alkenyl group having up to 20 carbon atoms, a saturated or unsaturated cycloaliphatic radical, an aromatic radical or a combination of the above. The stopper may be, for example, laurylamine or oleylamine.

Advantageously, the amine-terminated polyamide has a molecular weight between 1000 and 5000 g/mol and preferably between 2000 and 4000.

The preferred amino acid or lactam monomers for the synthesis of the monoamine oligomer according to the invention are chosen from caprolactam, 11-aminoundecanoic acid or dodecalactam. The preferred monofunctional polymerization stoppers are laurylamine and oleylamine.

The polycondensation defined above is carried out according to commonly known methods, for example at a temperature generally between 200 and 300° C., under vacuum or in an inert atmosphere, with stirring of the reaction mixture. The average chain length of the oligomer is determined by the initial molar ratio of the polycondensable monomer or the lactam to the monofunctional polymerization stopper. To calculate the average chain length, one molecule of chain stopper is usually counted per one oligomer chain.

The addition of the polyamide monoamine oligomer to the polyolefin backbone containing X is carried out be reaction of one amine functional group of the oligomer with X. Advantageously X bears an anhydride or acid functional group, thus amide or imide bonds are created.

The addition of the amine-terminated oligomer to the polyolefin backbone containing X is preferably carried out in the melt state. Thus the oligomer and the backbone can be kneaded, in an extruder, at a temperature generally between 230 and 280° C. The average residence time of the molten material in the extruder may be between 15 seconds and 5 minutes, and preferably between 1 and 3 minutes. The efficiency of this addition is evaluated by selective extraction of the free polyamide oligomers, that is to say those that have not reacted to form the final graft copolymer having polyamide blocks.

The preparation of such amine-terminated polyamides and also their addition to a polyolefin backbone containing X is described in U.S. Pat. No. 3,976,720, U.S. Pat. No. 3,963,799, U.S. Pat. No. 5,342,886 and FR 2 291 225.

The graft copolymers having polyamide blocks used in the thermoplastic compositions according to the present invention are characterized by a nanostructured arrangement with polyamide lamellae having a thickness between 10 and 50 nanometers.

These copolymers have very good creep resistance at temperatures at least equal to 80° C. and possibly ranging up to 130° C., that is to say that they do not break under 25 kPa.

The copolymers used in the invention may be prepared by melt-blending in extruders (single-screw or twin-screw), Buss kneaders, Brabender mixers and, in general, the usual devices for blending thermoplastics, and preferably in twin-screw extruders.

The thermoplastic compositions used according to the invention may also comprise processing aids such as silica, ethylenebisamide, calcium stearate or magnesium stearate. They may also comprise heat stabilizers, antioxidants, UV stabilizers, mineral fillers and coloring pigments.

The compositions of the invention may be prepared in one step in an extruder. In the first zones, the backbone containing X (for example an ethylene/alkyl (meth)acrylate/maleic anhydride copolymer) and the amine-terminated polyamide are introduced, then, several zones later, the additives are introduced. It is also possible to introduce all the ingredients into the first zone of the extruder.

### DESCRIPTION OF EXEMPLARY EMBODIMENTS OF THE INVENTION

Three thermoplastic compositions A, B and C, being in the form of a co-continuous nanostructured blend, were produced from the following components whose contents, in parts by weight, are given in Table 1 below:

TABLE 1

| | A | B | C |
|---|---|---|---|
| LOTADER 4700 | 80 | | |
| LOTADER 7500 | | 80 | |
| LOTADER 3210 | | | 80 |
| Mono-NH₂ PA-6 | 19 | 19 | 19 |
| IRGAFOS 168 | 0.5 | 0.5 | 0.5 |
| IRGANOX 1098 | 0.5 | 0.5 | 0.5 |

LOTADER 4700® from Arkema is an ethylene/ethyl acrylate (29 wt %)/maleic anhydride (1.5 wt %) terpolymer having a MFI of 7 (g/10 min measured at 190° C. under a load of 2.16 kg, according to the standard ASTM D 1238).

LOTADER 7500® from Arkema is an ethylene/ethyl acrylate (17.5 wt %)/maleic anhydride (2.9 wt %) terpolymer having an MFI of 70.

LOTADER 3210® from Arkema is an ethylene/butyl acrylate (6 wt %)/maleic anhydride (3 wt %) terpolymer having an MFI of 5.

The mono-NH₂-terminated PA-6 has a molecular weight of 2500 g/mol.

IRGANOX 1098 is an antioxidant from CIBA.

IRGAFOS 168 is a stabilizer from CIBA.

These components were introduced into a LEISTRITZ® LSM 306-34 co-rotating twin-screw extruder having a temperature profile between 240 and 280° C., the product obtained being bagged after granulation.

### Tube Extrusion

Various monolayer and two-layer tubes were extruded with compositions A and B. For the monolayer an inner diameter of 6 mm and an outer diameter of 8 mm were chosen. The two-layer tubes were coextruded with an inner layer made of RILSAN® (type BESN BLACK P20 TL) from Arkema, and an outer layer with compositions A and B, (each layer having a thickness of 1 mm), and had the following dimensions: inner diameter of 6 mm, total outer diameter of 10 mm.

### Hydrolysis Resistance

The monolayer tubes (composition A) were aged in a mixture of water/HAVOLINE XLC from Texaco (ethylene glycol plus additives) (50/50 by weight) and the change in mechanical properties after aging for 1000 h in this water/HAVOLINE mixture at 130° C. were measured at 23° C.; a comparative test with a SANTOPRENE 8000 RUBBER 8201-90 type composition (sold by Advanced Elastomer Systems) based on polypropylene (PP) and on an ethylene-propylene-diene monomer (EPDM) copolymer was also carried out. The results obtained are given in Table 2 below.

TABLE 2

| Water/HAVOLINE aging at 130° C. | |
|---|---|
| | Comparative: |
| Composition A | PP + EPDM |

| | Tensile | Elongation | Tensile | Elongation |
|---|---|---|---|---|
| | strength | at break | strength | at break |
| Time (h) | (MPa) | (%) | (MPa) | (%) |
| 0 | 8.3 | 467 | 6.5 | 315 |
| 1000 | 9.4 | 512 | 6.3 | 100 |

### Heat Aging Resistance:

The monolayer tubes produced with composition A and also with a PP+EPDM composition as a comparison, were aged in air at various temperatures and the changes in the mechanical properties measured at 23° C. are given in Tables 3 and 4 below:

TABLE 3

| Aging at 150° C. | |
|---|---|
| | Comparative: |
| Composition A | PP + EPDM |

| | Tensile | Elongation | Tensile | Elongation |
|---|---|---|---|---|
| | strength | at break | strength | at break |
| Time (h) | (MPa) | (%) | (MPa) | (%) |
| 0 | 11.3 | 467 | 6.5 | 315 |
| 170 | 10.5 | 456 | 6.3 | 105 |
| 1000 | 10.2 | 432 | 3 | 20 |

TABLE 4

| Aging at 180° C. | |
|---|---|
| | Comparative: |
| Composition A | PP + EPDM |

| | Tensile | Elongation | Tensile | Elongation |
|---|---|---|---|---|
| | strength | at break | strength | at break |
| Time (h) | (MPa) | (%) | (MPa) | (%) |
| 0 | 11.3 | 467 | 6.5 | 315 |
| 168 | 9.3 | 344 | melted | melted |

### Resistance to Aging in Oil:

The monolayer tubes (produced with compositions A, B and C according to the invention) were aged according to the PSA/Renault D47 1924 standard (occasional contact):

These tubes and also a tube produced with a composition based on PP+EPDM (described above) were brought into contact with the Elf Trophy DX 15 W40 oil for 15 seconds at 23° C. Next, the tubes were placed in a ventilated oven at 155° C. for 16 h. No apparent change could be observed. This is why the tubes were evaluated according to the Volkswagen TL 524 35 standard (transverse tension).

The results are given in Table 5 below:

TABLE 5

| Elongation | Composition | Composition | Composition | Comparative |
|---|---|---|---|---|
| at break (%) | C | A | B | PP + EPDM |
| Initial | 456 | 451 | 473 | 314 |
| Aged for 16 h | 404 | 479 | 465 | 102 |
| at 155° C. | | | | |
| Aged for 16 h | 337 | 392 | 315 | 111 |
| at 155° C. | | | | |
| after 15 s | | | | |
| oil contact | | | | |

The heat aging had little or no influence on the mechanical properties of the compositions A, B and C unlike the composition based on PP+EPDM.

Two-Layer Structures with the Nanostructured Thermoplastic Compositions According to the Invention as a Thermally-Protective Outer Layer

Two-layer tubes were extruded and formed from an inner layer made of RILSAN® (BESN BLACK P20 TL) (thickness: 1 mm) and an outer layer (thickness: 1 mm) with the compositions A and B according to the invention; the inner diameter of the tubes was 6 mm and the outer diameter was 10 mm.

The tubes were evaluated according to the specifications PSA D44 1959 (rubber and plastics—resistance to mechanical friction), and SAE J2303 (thermal effectiveness of sleeve insulation) and the properties corresponded to the specifications.

1. A thermally protected substrate comprising a substrate having directly deposited thereon at least one layer of a thermoplastic composition in nanostructured form, wherein said thermoplastic composition consists essentially of a graft copolymer having polyamide blocks formed from a polyolefin backbone, chosen from ethylene/maleic anhydride and ethylene/alkyl(meth)acrylate/maleic anhydride copolymers, and from at least one polyamide graft, and optionally of additives selected from the group consisting of processing aids, heat stabilizers, antioxidants, UV stabilizers, mineral fillers and coloring pigments, wherein said thermoplastic composition provides the substrate with thermal protection, at a temperature above 150° C.

2. The thermally protected substrate as claimed in claim 1, wherein the polyolefin backbone is an ethylene/alkyl (meth)acrylate/maleic anhydride terpolymer.

3. The thermally protected substrate as claimed in claim 1, wherein the grafts are homopolymers formed from residues of caprolactam, 11-aminoundecanoic acid or dodecalactam or copolyamides formed from residues chosen from at least two of these three monomers.

4. The thermally protected substrate as claimed in claim 3, wherein the polyamide grafts are mono-NH₂-terminated PA-6 polyamide or mono-NH₂-terminated PA-6/11 copolyamide.

5. The thermally protected substrate as claimed claim 3, wherein the polyamide grafts have a molecular weight between 1000 and 5000 g/mol.

6. The thermally protected substrate as claimed in claim 1, wherein the substrate is flexible and produced from polyamide.

7. The thermally protected substrate as claimed in claim 6, characterized in that wherein the coating layer is deposited by coextrusion onto the substrate layer, in particular for producing pipes or tubes for petrol lines.

8. The thermally protected substrate as claimed in claim 1, wherein the substrate is rigid.

9. The thermally protected substrate as claimed in claim 1 wherein said composition provides the substrate with thermal stability at a temperature above 200° C.

10. The thermally protected substrate as claimed in claim 6 wherein the substrate is produced from polyamide 11 or polyamide 12.
